(19) United States
(12) Patent Application Publication
(10) Pub. No.: US 2022/0045863 A1
(43) Pub. Date: Feb. 10, 2022

(54) TRANSACTION MODE-BASED ELECTRONIC CONTRACT FORENSICS METHOD AND SYSTEM

(71) Applicant: Jiangsu Aowei Holdings Co., Ltd., Nanjing (CN)

(72) Inventor: Jie BAI, Nanjing (CN)

(73) Assignee: Jiangsu Aowei Holdings Co., Ltd., Nanjing (CN)

(21) Appl. No.: 17/379,188

(22) Filed: Jul. 19, 2021

(30) Foreign Application Priority Data
Jul. 20, 2020 (CN) 202010698698.4
Sep. 9, 2020 (CN) 202010938161.0

(51) Int. Cl. H04L 9/32; H04L 9/08

(52) U.S. Cl. CPC H04L 9/3242; H04L 2209/38; H04L 9/088; H04L 9/3247

(57) ABSTRACT

The present application provides a transaction-based electronic contract forensics method and system: when a user wants to perform forensics for an electronic contract in a blockchain digital deposit platform, initiating, by a present electronic contract platform, a forensics request for the electronic contract; obtaining, by the blockchain digital deposit platform, the forensics request and querying deposit information; obtaining a transaction hash value of the deposit information after the deposit information is queried; querying a deposit transaction corresponding to the deposit platform; obtaining a digest; decrypting the digest, to obtain a storage index table; verifying validity of a private-key signature of the deposit transaction; downloading transaction data of the deposit transaction according to a data index; decrypting the transaction data; and verifying validity, legitimacy, and integrity of the decrypted transaction data. A data source of electronic contract forensics is ensured by querying the deposit information and the corresponding deposit transaction, and credibility of electronic contract forensics is ensured by verifying the validity, the legitimacy, and the integrity of the transaction data, thereby achieving an electronic contract forensics process.

The present application claims the priority to the Chinese Application No. 202010698698.4, filed with the China National Intellectual Property Administration on Jul. 20, 2020 and entitled “TRANSACTION-BASED ELECTRONIC CONTRACT FORENSICS METHOD AND SYSTEM”, which is incorporated herein by reference in its entirety.

### FIELD OF THE INVENTION

The present invention relates to a field of electronic contract forensics technologies, and in particular, to a transaction-based electronic contract forensics method and system.

### BACKGROUND OF THE INVENTION

With popularization and development of the Internet, electronic information exchange such as e-commerce and e-government, and electronic transactions have gradually penetrated into all levels of the economy and society. Internet applications play an important role in propelling the national economy and the society informationization. In economic and social activities, two or more parties are increasingly choosing to reach agreements in an electronic form through electronic information networks, and conclude electronic contracts on the Internet.

The electronic contracts have been under the protection of the law, and therefore also have legal effects. The electronic contracts have been widely used due to characteristics such as being easy for storage and being convenient for use. Referring to FIG. 1, FIG. 1 is a schematic scenario diagram illustrating centralized storage of a prior electronic contract platform. Each enterprise has an own electronic contract platform, to store internal electronic contracts of the enterprise and related data. For example, in FIG. 1, enterprise A corresponds to an electronic contract platform A, enterprise N corresponds to an electronic contract platform N, and a plurality of enterprises correspond to a plurality of electronic contract platforms. In a prior electronic contract management platform, electronic contracts and related data of a plurality of electronic contract platforms are stored in a same centralized system. For example, the most common storage manner is storing in a database. Referring to the database storage table shown in FIG. 1, data about all the electronic contract platform of all enterprises may be centrally stored, that is, stored in a centralized way, in the table.

However, because there is only one centralized database, there are risks of data loss, tampering, and forgery. Information security of electronic contract data retained on the Internet presents a serious challenge, and credibility in deposit and forensics is also under question.

### SUMMARY OF THE INVENTION

The present application provides a transaction-based electronic contract forensics method and system, to resolve a problem that credibility of electronic contract forensics cannot be ensured.

According to a first aspect, the present application provides a transaction-based electronic contract forensics method, including:

obtaining a digest of a corresponding deposit transaction based on a forensics request for an electronic contract;

decrypting the digest to generate a storage index table;

downloading corresponding distributed storage data according to the storage index table and splicing the data to obtain transaction data;

decrypting the transaction data; and

verifying validity, legitimacy, and integrity of the decrypted transaction data, to generate a forensics report.

According to a second aspect, the present application provides a transaction-based electronic contract forensics system, including an electronic contract platform configured to initiate a forensics request, and a blockchain digital deposit platform that receives the forensics request, and stores and retrieves an electronic contract based on a transaction, where

the electronic contract platform is configured with:

a request initiation step: initiating a forensics request for the electronic contract;

the blockchain digital deposit platform is configured with:

a digest obtaining step: obtaining a digest of a corresponding deposit transaction based on the forensics request for the electronic contract;

a storage index table generation step: decrypting the digest to generate a storage index table;

a transaction data generation step: downloading corresponding distributed storage data according to the storage index table and splicing the data to obtain transaction data;

a transaction data decryption step: decrypting the transaction data; and

a verification step: verifying validity, legitimacy, and integrity of the decrypted transaction data, to generate a forensics report; and

the electronic contract platform is further configured with:

a forensics report generation step: receiving the verification result sent by the blockchain digital deposit platform, to generate the forensics report.

According to a third aspect, the present application provides a transaction-based electronic contract forensics system, including an electronic contract platform configured to initiate a forensics request, and a blockchain digital deposit platform that receives the forensics request, and stores and retrieves an electronic contract based on a transaction, where

the electronic contract platform is configured with:

a request initiation step: initiating a forensics request for the electronic contract;

the blockchain digital deposit platform is configured with:

a digest obtaining step: obtaining a digest of a corresponding deposit transaction based on the forensics request for the electronic contract;

a storage index table generation step: decrypting the digest to generate a storage index table;

a transaction data generation step: downloading corresponding distributed storage data according to the storage index table and splicing the data to obtain transaction data; and

a transaction data decryption step: decrypting the transaction data;

the electronic contract platform is further configured with:

a verification step: verifying validity, legitimacy, and integrity of the decrypted transaction data, and transmitting a verification result to the blockchain digital deposit platform; and

the blockchain digital deposit platform is further configured with:

a forensics report generation step: receiving the verification result, of the decrypted transaction data, that is transmitted by the electronic contract platform, to generate a forensics report.

It may be learned from the foregoing technical solutions that the present application provides a transaction-based electronic contract forensics method and system. When a user wants to perform forensics for an electronic contract in the blockchain digital deposit platform, the present electronic contract platform initiates the forensics request for the electronic contract. The blockchain digital deposit platform obtains the forensics request and queries the deposit information. A transaction hash value of the deposit information is obtained after the deposit information is queried. The deposit transaction corresponding to the deposit platform is queried. The digest is obtained. The digest is decrypted to obtain the storage index table. Validity of a private-key signature of the deposit transaction is verified. The transaction data of the deposit transaction is downloaded according to a data index. The transaction data is decrypted. The validity, the legitimacy, and the integrity of the decrypted transaction data are verified. A data source of electronic contract forensics is ensured by querying the deposit information and the corresponding deposit transaction, and credibility of electronic contract forensics is ensured by verifying the validity, the legitimacy, and the integrity of the transaction data, thereby completing an electronic contract forensics process.

### BRIEF DESCRIPTION OF THE DRAWINGS

To more clearly describe the technical solutions of the present application, the accompanying drawings to be used in the embodiments are briefly described below. Obviously, persons of ordinary skills in the art can also derive other accompanying drawings according to these accompanying drawings without an effective effort.

FIG. 1 is a schematic scenario diagram illustrating centralized storage of a prior electronic contract platform;

FIG. 2 is a schematic topology diagram illustrating depositing an electronic contract in a blockchain digital deposit platform;

FIG. 3 is a flowchart of a transaction-based electronic contract forensics method according to the present application;

FIG. 4 is schematic scenario diagram illustrating a deposit transaction of an electronic contract;

FIG. 5 is a schematic diagram illustrating hierarchically storing transaction data;

FIG. 6 is a schematic diagram illustrating downloading transaction data through a storage index table;

FIG. 7 is a schematic diagram illustrating a transaction-based electronic contract forensics system according to an embodiment of the present application; and

FIG. 8 is a schematic diagram illustrating a transaction-based electronic contract forensics system according to another embodiment of the present application.

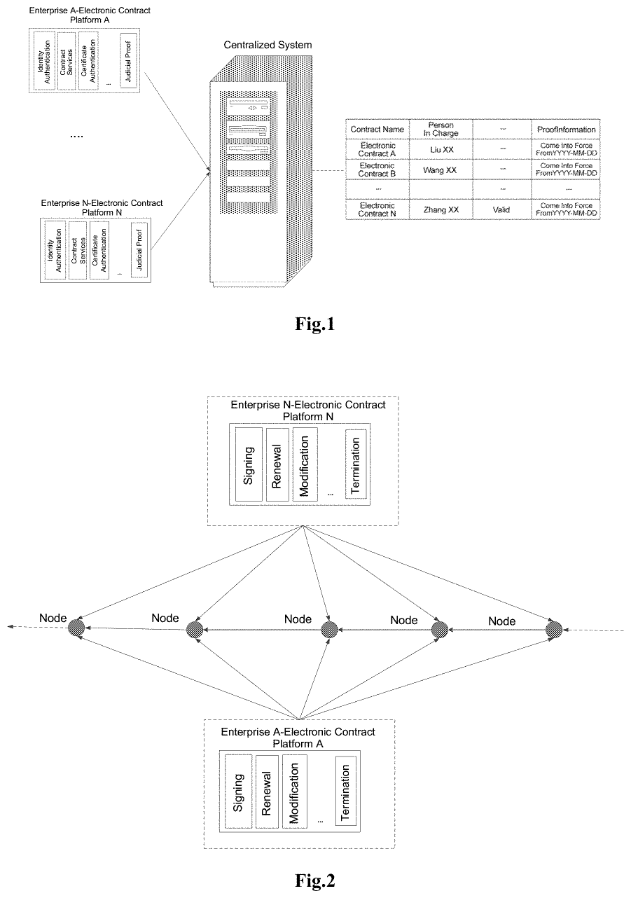

### DETAILED DESCRIPTION OF THE EMBODIMENTS

To make objectives, technical solutions, and advantages of the present application more clear, the technical solutions of the present application are clearly and completely described below with reference to specific embodiments and corresponding accompanying drawings in the present disclosure. Obviously, the described embodiments are merely some and not all of embodiments of the present application. According to the embodiments in the present disclosure, all other embodiments derived by persons of ordinary skills in the art without an effective effort fall within the protection scope of the present application. The technical solutions provided in the embodiments of the present disclosure are described in detail below with reference to the accompanying drawings.

To improve credibility of electronic contract deposit, usually transaction operations of the electronic contract, such as signing, renewal, modification, and termination, have been deposited in a blockchain digital deposit platform. Referring to FIG. 2, FIG. 2 is a schematic topology diagram illustrating depositing an electronic contract in a blockchain digital deposit platform. The electronic contract is deposited based on an electronic contract platform in combination with the blockchain technology, so as to ensure the credibility of the electronic contract deposit through characteristics of a blockchain, such as decentralization, cannot be tampered with, leaving tracks throughout the process, being traceable, being collectively maintained, and being open and transparent. Different from a prior centralized storage method for an electronic contract, in the blockchain digital deposit platform, the electronic contract and related data are stored in various nodes in the blockchain. Therefore, even if data in one or more nodes is damaged, there still are a lot of nodes where the data is stored. In this way, security of the electronic contract and the related data is ensured. In other words, the electronic contract deposit is credible. To ensure forensics credibility, the present application provides a transaction-based electronic contract forensics method and system.

Prior to specific embodiments, in order to clearly describe and facilitate further understanding of this solution, actual scenarios of a deposit transaction and a forensics transaction are introduced below, which are divided into substantially two cases.

Case I: It is known which one of the blockchain digital deposit platforms is where a deposit transaction to be performed with forensics is stored. Regarding this case, after a forensics transaction is initiated to the blockchain digital deposit platform based on a forensics request for an electronic contract, forensics may be directly performed.

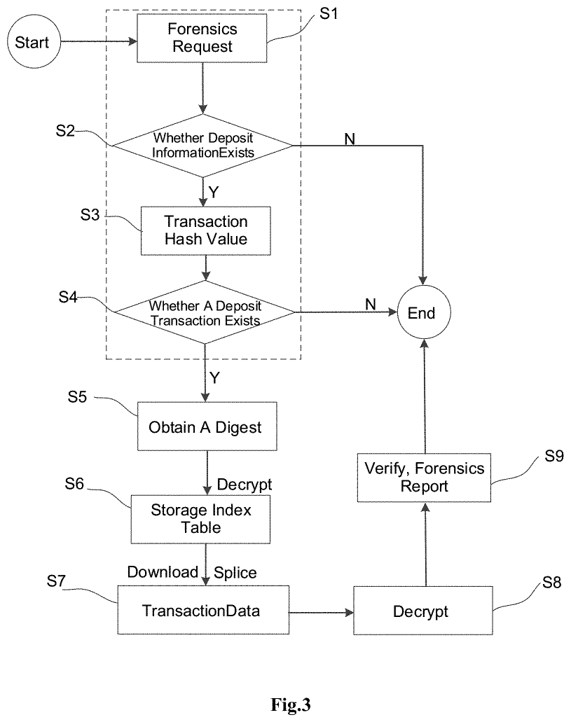

Case II: It is unknown which one of the blockchain digital deposit platforms is where a deposit transaction to be performed with forensics is stored. There are relatively a lot of blockchain digital deposit platforms, or a forensics request may include unqualified information and the like. Regarding this case, after a forensics transaction is initiated to the blockchain digital deposit platform based on a forensics request for an electronic contract, necessary determining is required. Referring to FIG. 3, FIG. 3 is a flowchart of a transaction-based electronic contract forensics method according to the present application. When a user needs to query and retrieve an electronic contract in the blockchain digital deposit platform, a specific implementation process is described with reference to case II, where the following steps are included (correspondingly, if it belongs to case I, steps S1 to S4 in the dashed box may be skipped. In other words, it is default that the deposit transaction is in a certain blockchain digital deposit platform, a digest of the deposit transaction may be directly obtained).

S1: Obtain a forensics request for an electronic contract.

When a user wants to query and retrieve an electronic contract in the blockchain digital deposit platform, first, a forensics request is initiated through a prior electronic contract platform. For example, the prior electronic contract platform may have a forensics request button, and when the button is pressed, the prior electronic contract platform may trigger a forensics request to the blockchain digital deposit platform, that is, intending to query and retrieve the electronic contract, and the blockchain digital deposit platform obtains the forensics request. In the present application, when querying and retrieving an electronic contract in the blockchain digital deposit platform, a specific operation method may be carried in the blockchain digital deposit platform, or may be carried on a node that provides proof services. For example, a service node is responsible for maintaining a table, where the table shows which electronic contract is deposited and in which blockchain digital deposit platform the electronic contract is stored. A deposit transaction may have a corresponding serial number. When querying, it may be determined upon entering the serial number whether a blockchain digital deposit platform deposits a transaction of the electronic contract.

S2: Determine, based on the forensics request, whether deposit information corresponding to the electronic contract is stored in the blockchain digital deposit platform. To perform a forensics for an electronic contract in the blockchain digital deposit platform, it is required to confirm whether the electronic contract is deposited in the blockchain digital deposit platform, that is, to query whether deposit information of the electronic contract exists in the blockchain digital deposit platform. Whether the deposit information corresponding to the electronic contract is stored in the blockchain digital deposit platform is determined. If the deposit information exists, it is indicated that the electronic contract has been stored in the blockchain digital deposit platform in advance; and if this result is queried, a next step may be performed. If the deposit information does not exist, it is indicated that the electronic contract is not stored in the blockchain digital deposit platform in advance, and if this result is not queried, the query is directly ended.

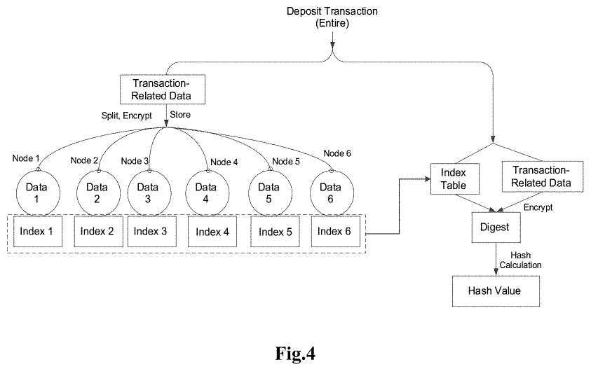

For ease of understanding, a specific use scenario of the deposit transaction of the electronic contract is further introduced herein. Referring to FIG. 4, FIG. 4 is a schematic scenario diagram illustrating a deposit transaction of an electronic contract. Deposit is to save data of a transaction and specific content thereof to the blockchain digital deposit platform. The transaction herein represents a series of operations on the blockchain. The deposit transaction is to save data of specific content corresponding to the deposit transaction to the blockchain digital deposit platform, and forensics is to retrieve data related to the deposit transaction.

During an actual operation, a deposit transaction necessarily involves an operation instruction and specific data content, and a transaction result is formed after a specific transaction. During the transaction, a data volume of specific data content may be very large. For example, taking electronic contract deposit as an example, the specific data content may include specific contract terms, information about contracting parties, a contract transaction quantity, and the like. If audio, videos, and other content are involved, a storage capacity may be larger. On this basis, in order to facilitate storage and security of data, usually all data of a transaction may be divided into two parts. By a deposit transaction as an example, referring to

FIG. 4, a deposit transaction is taken as a whole, for example, may be a data packet or a data set. In order to facilitate storage and ensure data security, the whole of data is divided into two parts, and details are described as follows.

The first part of the data includes specific transaction-related data stored in the node and a storage relationship index table. In the present application, the deposit transaction is stored as a whole, and may be stored in a node in the blockchain digital deposit platform. The node herein may be a dedicated data storage center. In other words, the node serves as a data center, i.e., indicating where the data is stored. A processing process includes encrypting and splitting a whole of deposit transaction, i.e., all specific data of the transaction, into a plurality of blocks, or first splitting the all specific data of the transaction into a plurality of blocks and then encrypting the same. For example, the whole of deposit transaction-related data is split into six pieces, which are respectively stored in six nodes, where the transaction-related data herein is specific transaction data during the deposit transaction. At this time, each node corresponds to a piece of data. Correspondingly, an index is generated for each piece of data stored in the node, and the index is an indication of a storage location of each piece of data. For example, index 1 is generated for data 1 stored in node 1, and index 2 is generated for data 2 stored in node 2. All indexes form a storage relationship index table about all specific transaction data. In FIG. 4, indexes 1 to 6 form a storage index table about the integral transaction data.

The second part of the data includes a digest data, involving the storage relationship index table and the transaction-related data in the first part of the data. The transaction-related data herein may refer to, for example, information about both parties of the transaction, a transaction form, transaction expiration and the like. Because an overall data volume of a deposit transaction is very large, it is impractical to store all real data in the blockchain digital deposit platform. If the deposit transaction is entirely packed by using a key, that is, the deposit transaction is encrypted by using the key to become to have a fixed-length byte, for example, a digest is formed after the entire transaction-related data, i.e., the specific transaction data of the deposit transaction, is performed with a hash operation. Representation of the digest may be a string of hash values, which may become, for example, 256 or 512 bytes after being encrypted, and then the digest is stored in the blockchain digital deposit platform. Because the digest is a package for the entire deposit transaction, the digest also includes the storage relationship index table in the first part of the data. To know which piece of data is stored in which node, it is merely needed to find out a block where the digest is located, and decrypt the digest to find the index table.

In view of the above, the digest is formed through the following process. The transaction data of the whole of deposit transaction (that is, the transaction-related data) is encrypted, and is performed with a hash operation together with a storage index table generated after distributed storage, to form a digest. In view of the above, the digest is also encrypted.

S3: If the deposit information is stored in the blockchain digital deposit platform, obtain a transaction hash value corresponding to the deposit information.

If deposit information corresponding to a contract is stored in the blockchain digital deposit platform, a transaction hash value corresponding to the deposit information is obtained. According to the transaction hash value corresponding to the deposit information, it may be determined whether there is a corresponding deposit transaction in the blockchain digital deposit platform.

S4: Determine, based on the transaction hash value, whether the deposit transaction exists in the blockchain digital deposit platform.

The corresponding deposit transaction is queried in the blockchain digital deposit platform by using the transaction hash value. The deposit transaction herein refers to the whole of the deposit transaction in FIG. 4, and generally refers to a transaction saved as evidence being stored in a block. One deposit transaction corresponds to one hash value. For example, there may be a query box in the blockchain digital deposit platform, and it may be queried whether the deposit transaction of the electronic contract to be queried exists, by entering a keyword or the corresponding transaction hash value. If the deposit transaction exists in the blockchain digital deposit platform, a subsequent step may be performed; and if the deposit transaction does not exist, the query is directly ended.

S5: If the deposit transaction exists in the blockchain digital deposit platform, obtain a digest of the deposit transaction.

If the deposit transaction of the electronic contract to be queried exists in the blockchain digital deposit platform, that is, when a query result is “Yes”, the digest of the deposit transaction of the electronic contract is obtained. Because the electronic contract is deposited in the blockchain digital deposit platform in an encrypted form, the digest obtained at this time is also encrypted.

S6: Decrypt the digest, to generate a storage index table.

For a process of decrypting the digest, a specific encryption and decryption methods may be set in advance, which are not specifically limited in the present application. A storage index table is generated after the digest is decrypted. It should be noted that before this step, validity of a private-key signature of the deposit transaction may be verified. A specific verification manner is not specifically limited in the present application. If the private-key signature of the deposit transaction is valid, a next step may be performed. If the private-key signature of the deposit transaction is invalid, query is ended.

The private-key signature of the deposit transaction may include a form of a digital signature. Taking a validity verification method of the digital signature as an example of a validity verification method of the private-key signature, for a case when a sending party sends a file with a digital signature to the receiving party, a sending and verifying process may include: generating by the sending party a verification digest for a file to be sent by using a cryptographic hash function (such as MD5, SHA, or SM3); and encrypting the verification digest by the sending party by using a private key thereof and forming the digital signature, and then sending the file along with the digital signature to the receiving party. The receiving party decryptes the digital signature by using a public key corresponding to the private key of the sending party to obtain the verification digest generated by the sending party, and generates a verification digest for the received file by using SHA encoding. The verification digest obtained based on decryption is compared with the verification digest for the received file generated by the receiver. If the two are consistent, it is indicated that the file is not destroyed or tampered with during a transmission process, and the data is complete. In this case, it is verified that the digital signature is valid.

The storage index table records a specific storage location of the transaction data. When the index table is obtained, it is equivalent to that a specific location of the data is learned. By obtaining a data index, data query efficiency may be accelerated, and particular information in a database table may be quickly accessed.

Usually, to further ensure data security, the data is stored in a distributed manner.

However, there is also a case in which the data stored as a whole. To be specific, the specific transaction data of the whole deposit transaction is not split, and is directly stored in one node or data center, and then an index is generated. It is equivalent to that one-level storage corresponds to one index. However, in most cases, the data is still selected to be stored in a distributed way, that is, the data is split into a plurality of pieces of data, which are stored in different locations.

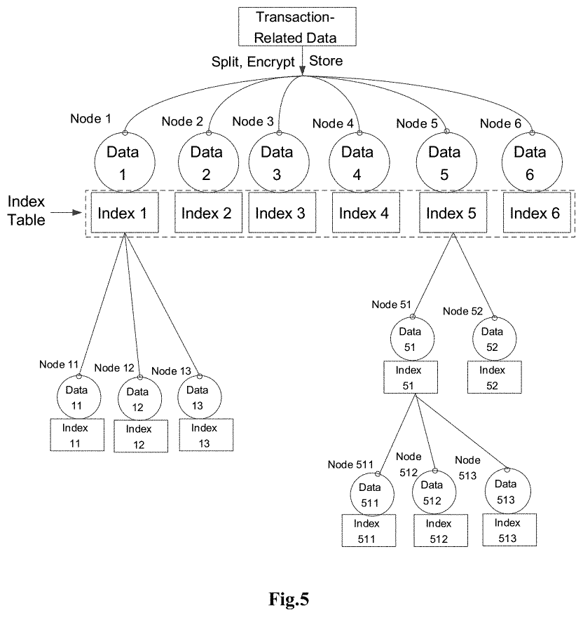

Referring to FIG. 5, FIG. 5 is a schematic diagram illustrating hierarchically storing transaction data. With reference to specific examples, hierarchical storage in distributed storage is introduced in detail.

Regarding one-level storage, the data is merely split into a plurality of pieces and is distributed in different nodes or data centers, including the case of directly storing the entire transaction data that is described above. If the entire data is stored in a node A, a corresponding index is A, and there is a sub-index A1 under the index A. If A1 is empty, it indicates that the data is not stored at a next level, which means that the data is stored only at one level.

Regarding hierarchical storage (storage at two or more levels), with reference to FIG. 5, transaction-related data is stored in a node 1 including several subnodes, where an index 1 is correspondingly generated. The data stored is further stored in next-level nodes, where the data is divided into three pieces to be stored in next-level nodes 11, 12, and 13, and sub-indexes which respectively are index 11, index 12, and index 13 are generated. It may be learned from FIG. 5 that the three sub-indexes together constitute the index 1, and the storage at this time is two-level storage. Similarly, with reference to node 5, the node 5 stores the data to next-level subnodes 51 and 52 in a distributed way. The subnode 51 further stores the data to its next-level subnodes 511, 512, and 513 in a distributed way. Corresponding storage at this time is three-level storage. The other may be obtained by analogy. Hierarchical storage may be performed according to actual requirements.

S7: Download corresponding distributed storage data according to the storage index table and splicing the data to obtain transaction data.

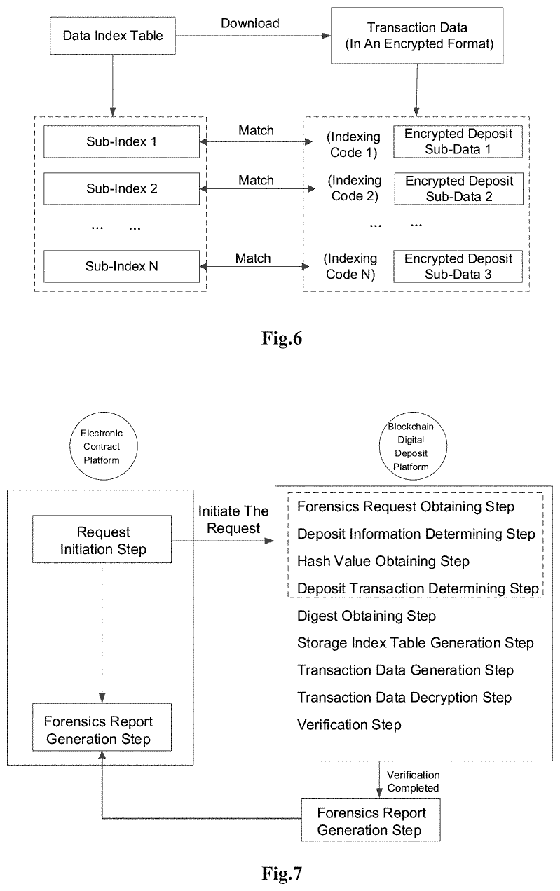

For a specific process of downloading corresponding distributed storage data according to the storage index table, referring to FIG. 6. FIG. 6 is a schematic diagram illustrating downloading transaction data through a storage index table. It may be learned from FIG. 6 that the storage index table may be split into a plurality of sub-indexes, that is, may include a plurality of sub-indexes, such as sub-index 1, sub-index 2, . . . , and sub-index n. The transaction data may include a plurality pieces of discretized encrypted deposit sub-data, and each of the pieces of the encrypted deposit sub-data has an indexing code. For example, an indexing code of encrypted deposit sub-data 1 is indexing code 1, and an indexing code of encrypted deposit sub-data n is indexing code n, where the indexing code is unique. In other words, there is no duplication in the plurality of indexing codes. In a process of downloading deposit data by using the storage index table, the plurality of sub-indexes of the storage index table are respectively matched with the plurality of indexing codes of the deposit data. If the sub-index and the indexing code are successfully matched, it is indicated that there may be encrypted deposit sub-data that matches with the sub-index. For example, upon comparison, it is found that if the sub-index 1 matches with the indexing code 1, it is indicated that the encrypted deposit sub-data 1 may be downloaded according to the sub-index 1. In other words, after the successful matching, the encrypted deposit sub-data corresponding to the indexing code that matches with the sub-index is downloaded. After all indexing codes matching with the sub-indexes are found, all successfully matched encrypted deposit sub-data is downloaded.

These encrypted deposit sub-data forms the transaction data after being correctly spliced.

S8: Decrypt the transaction data.

Before step S6, validity of private key information of the user or the electronic contract platform may be verified. If the private-key signature is verified to be valid, in this step, the encrypted transaction data is decrypted by using a valid private key, to generate corresponding decrypted transaction data.

S9: Verify validity, legitimacy, and integrity of the decrypted transaction data, to generate a forensics report.

To ensure credibility of the decrypted transaction data, the validity, the legitimacy, and the integrity of the decrypted transaction data need to be verified. For example, integrity of the transaction data may be verified according to a digital signature. A method for verifying the validity, the legitimacy, and the integrity is not specifically limited in the present application. A corresponding forensics report may be generated based on a verification result. For example, after the validity, the legitimacy, and the integrity of the transaction data pass the verification, it is indicated that the electronic contract obtained through forensics comes from the blockchain digital deposit platform, and is not damaged in deposit and forensics processes with integral data, thereby ensuring forensics credibility. For a case in which the verification is passed, the forensics report may contain relevant statements about that the verification is passed. If the verification is not passed, there may be descriptions in the forensics report about that the verification is not passed. A forensics report is generated after the validity, the legitimacy, and the integrity of the transaction data are verified, and forensics is ended. Till this time, forensics of the electronic contract is completed.

It may be learned from the foregoing technical solutions that the present application provides a transaction-based electronic contract forensics method. When a user wants to perform forensics for an electronic contract in the blockchain digital deposit platform, the present electronic contract platform initiates the forensics request for the electronic contract. The blockchain digital deposit platform obtains the forensics request and queries the deposit information. A transaction hash value of the deposit information is obtained after the deposit information is queried. The deposit transaction corresponding to the deposit platform is queried. The digest of the deposit transaction is obtained. The validity of the private-key signature of the deposit transaction is verified. The digest is decrypted to obtain the storage index table. The transaction data is downloaded according to the storage index table. The transaction data is decrypted. The validity, the legitimacy, and the integrity of the decrypted transaction data are verified. A data source of electronic contract forensics is ensured by querying the deposit information and the corresponding deposit transaction, and credibility of electronic contract forensics is ensured by verifying the validity, the legitimacy, and the integrity of the decrypted transaction data, thereby completing an electronic contract forensics process.

The present application provides a transaction-based electronic contract forensics system, including an electronic contract platform configured to initiate a forensics request, and a blockchain digital deposit platform that receives the forensics request, and stores and retrieves an electronic contract based on a transaction.

### Embodiment 1

Referring to FIG. 7, FIG. 7 is a schematic diagram illustrating a transaction-based electronic contract forensics system according to an embodiment of the present application. The parts in the dashed box in FIG. 7 are optional processes, which represent determining of some conditions before forensics is actually performed. To be specific, in case I, these processes do not exist; and in case II, these processes exist. Steps respectively performed by an electronic contract platform and a blockchain digital deposit platform are clearly shown in FIG. 7.

The electronic contract platform is configured with:

a request initiation step: initiating a forensics request for an electronic contract.

The blockchain digital deposit platform is configured with:

a digest obtaining step: obtaining a digest of a corresponding deposit transaction based on the forensics request for the electronic contract;

a storage index table generation step: decrypting the digest to generate a storage index table;

a transaction data generation step: downloading corresponding distributed storage data according to the storage index table and splicing the data to obtain transaction data;

a transaction data decryption step: decrypting the transaction data; and

a verification step: verifying validity, legitimacy, and integrity of the decrypted transaction data, to generate a forensics report.

The electronic contract platform is further configured with:

a forensics report generation step: receiving the verification result sent by the blockchain digital deposit platform to generate the forensics report.

Further, the obtaining a digest of a corresponding deposit transaction based on the forensics request for the electronic contract is performed according to the following steps:

a forensics request obtaining step: obtaining the forensics request for the electronic contract;

a deposit information determining step: determining, based on the forensics request, whether deposit information corresponding to the electronic contract is stored in the blockchain digital deposit platform;

a hash value obtaining step: if the deposit information is stored in the blockchain digital deposit platform, obtaining a transaction hash value corresponding to the deposit information;

a deposit transaction determining step: determining, based on the transaction hash value, whether the deposit transaction exists in the blockchain digital deposit platform; and

a digest obtaining step: if the deposit transaction exists in the blockchain digital deposit platform, obtaining the digest of the deposit transaction.

Further, the blockchain digital deposit platform is further configured with a step of verifying validity of a private key, to verify validity of a private-key signature of the deposit transaction. If the private-key signature is valid, the digest is decrypted to generate the storage index table.

Further, the transaction data includes several pieces of discretized encrypted deposit sub-data, each of the pieces of the encrypted deposit sub-data having an indexing code which is unique.

Further, the downloading corresponding distributed storage data according to the storage index table and splicing the data to obtain transaction data includes the following steps:

splitting the storage index table into several sub-indexes;

respectively matching the sub-indexes with the plurality of indexing codes, and if the sub-index is successfully matched with the indexing code, downloading the encrypted deposit sub-data corresponding to the indexing code; and

splicing the plurality pieces of encrypted deposit sub-data to form the transaction data.

### Embodiment 2

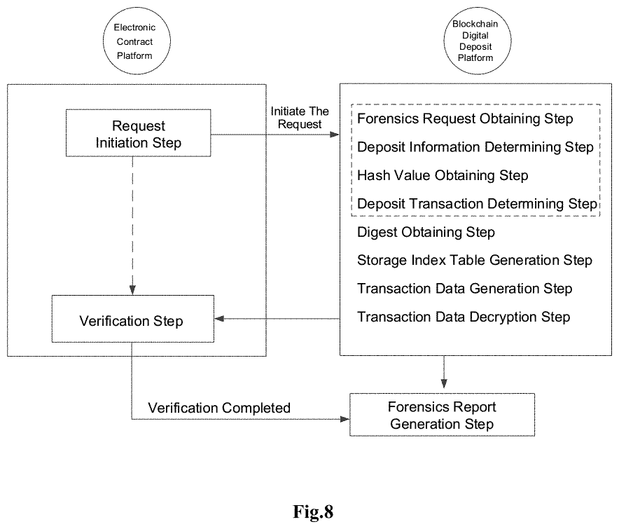

A transaction-based electronic contract forensics system is provided, including an electronic contract platform configured to initiate a forensics request, and a blockchain digital deposit platform that receives the forensics request, and stores and retrieves an electronic contract based on a transaction. Referring to FIG. 8, FIG. 8 is a schematic diagram illustrating a transaction-based electronic contract forensics system according to another embodiment of the present application. The parts in the dashed box in FIG. 8 are optional processes, which represent determining of some conditions before forensics is actually performed. To be specific, in case I, these processes do not exist; and in case II, these processes exist.

The electronic contract platform is configured with:

a request initiation step: initiating a forensics request for an electronic contract.

The blockchain digital deposit platform is configured with:

a digest obtaining step: obtaining a digest of a corresponding deposit transaction based on the forensics request for the electronic contract;

a storage index table generation step: decrypting the digest to generate a storage index table;

a transaction data generation step: downloading corresponding distributed storage data according to the storage index table and splicing the data to obtain transaction data; and

a transaction data decryption step: decrypting the transaction data.

The electronic contract platform is further configured with:

a verification step: verifying validity, legitimacy, and integrity of the decrypted transaction data, and transmitting a verification result to the blockchain digital deposit platform.

The blockchain digital deposit platform is further configured with:

a forensics report generation step: receiving the verification result, of the decrypted transaction data, that is transmitted by the electronic contract platform to generate a forensics report.

Further, the obtaining a digest of a corresponding deposit transaction based on the forensics request for the electronic contract is performed according to the following steps:

a forensics request obtaining step: obtaining the forensics request for the electronic contract;

a deposit information determining step: determining, based on the forensics request, whether deposit information corresponding to the electronic contract is stored in the blockchain digital deposit platform;

a hash value obtaining step: if the deposit information is stored in the blockchain digital deposit platform, obtaining a transaction hash value corresponding to the deposit information;

a deposit transaction determining step: determining, based on the transaction hash value, whether the deposit transaction exists in the blockchain digital deposit platform; and

a digest obtaining step: if the deposit transaction exists in the blockchain digital deposit platform, obtaining the digest of the deposit transaction.

Further, the blockchain digital deposit platform is further configured with a step of verifying validity of a private key, to verify validity of a private-key signature of the deposit transaction. If the private-key signature is valid, the digest is decrypted to generate the storage index table.

Further, the transaction data includes several pieces of discretized encrypted deposit sub-data, each of the pieces of the encrypted deposit sub-data having an indexing code which is unique.

Further, the downloading corresponding distributed storage data according to the storage index table and splicing the data to obtain transaction data includes the following steps:

splitting the storage index table into several sub-indexes;

respectively matching the sub-indexes with the plurality of indexing codes, and if the sub-index is successfully matched with the indexing code, downloading the encrypted deposit sub-data corresponding to the indexing code; and

splicing the plurality pieces of encrypted deposit sub-data to form the transaction data.

The difference between Embodiment 2 and Embodiment 1 is that in embodiment 1, the validity, the legitimacy, and the integrity of the decrypted transaction data are verified by the blockchain digital deposit platform; if the validity, the legitimacy, and the integrity of the decrypted transaction data pass the verification, the blockchain digital deposit platform sends a verification result to the electronic contract platform, that is, the blockchain digital deposit platform performs a forensics report triggering step; and the forensics report is generated by the electronic contract platform. Moreover, in Embodiment 2, the validity, the legitimacy, and the integrity of the decrypted transaction data are verified by the electronic contract platform; the verification result is transmitted to the blockchain digital deposit platform; and the blockchain digital deposit platform receives the verification result, of the decrypted transaction data, that is transmitted by the electronic contract platform, to generate the forensics report. Transaction-based electronic contract forensics may be achieved by each of the two embodiments.

What is claimed is:

1. A transaction-based electronic contract forensics method, comprising:
obtaining a digest of a corresponding deposit transaction based on a forensics request for an electronic contract;
decrypting the digest to generate a storage index table;
downloading corresponding distributed storage data according to the storage index table and splicing the data to obtain transaction data;
decrypting the transaction data; and
verifying validity, legitimacy, and integrity of the decrypted transaction data, to generate a forensics report.

2. The transaction-based electronic contract forensics method according to claim 1, wherein the obtaining a digest of a corresponding deposit transaction based on a forensics request for an electronic contract is performed according to the following steps:
obtaining the forensics request for the electronic contract;
determining, based on the forensics request, whether deposit information corresponding to the electronic contract is stored in the blockchain digital deposit platform;
obtaining a transaction hash value corresponding to the deposit information if the deposit information is stored in the blockchain digital deposit platform;
determining, based on the transaction hash value, whether the deposit transaction exists in the blockchain digital deposit platform; and
obtaining the digest of the deposit transaction if the deposit transaction exists in the blockchain digital deposit platform.

3. The transaction-based electronic contract forensics method according to claim 1, before the decrypting the digest, further comprising verifying validity of a private-key signature of the deposit transaction; and decrypting the digest to generate a storage index table, if the private-key signature is valid.

4. The transaction-based electronic contract forensics method according to claim 1, wherein the transaction data comprises several pieces of discretized encrypted deposit sub-data, each of the pieces of the encrypted deposit sub-data having an indexing code which is unique.

5. The transaction-based electronic contract forensics method according to claim 4, wherein the downloading corresponding distributed storage data according to the storage index table and splicing the data to obtain transaction data comprises the following steps:
splitting the storage index table into several sub-indexes;
respectively matching the sub-indexes with the plurality of indexing codes, and downloading the encrypted deposit sub-data corresponding to the indexing code if the sub-index is successfully matched with the indexing code; and
splicing the plurality pieces of encrypted deposit sub-data to form the transaction data.

6. A transaction-based electronic contract forensics system, comprising an electronic contract platform configured to initiate a forensics request, and a blockchain digital deposit platform that receives the forensics request, and stores and retrieves an electronic contract based on a transaction, wherein
the electronic contract platform is configured with:
a request initiation step: initiating a forensics request for the electronic contract;
the blockchain digital deposit platform is configured with:
a digest obtaining step: obtaining a digest of a corresponding deposit transaction based on the forensics request for the electronic contract;
a storage index table generation step: decrypting the digest to generate a storage index table;
a transaction data generation step: downloading corresponding distributed storage data according to the storage index table and splicing the data to obtain transaction data;
a transaction data decryption step: decrypting the transaction data; and
a verification step: verifying validity, legitimacy, and integrity of the decrypted transaction data, to generate a forensics report; and
the electronic contract platform is further configured with:
a forensics report generation step: receiving the verification result sent by the blockchain digital deposit platform to generate the forensics report.

7. The transaction-based electronic contract forensics system according to claim 6, wherein the obtaining a digest of a corresponding deposit transaction based on a forensics request for an electronic contract is performed according to the following steps:
a forensics request obtaining step: obtaining the forensics request for the electronic contract;
a deposit information determining step: determining, based on the forensics request, whether deposit information corresponding to the electronic contract is stored in the blockchain digital deposit platform;
a hash value obtaining step: obtaining a transaction hash value corresponding to the deposit information if the deposit information is stored in the blockchain digital deposit platform;
a deposit transaction determining step: determining, based on the transaction hash value, whether the deposit transaction exists in the blockchain digital deposit platform; and
a digest obtaining step: obtaining the digest of the deposit transaction if the deposit transaction exists in the blockchain digital deposit platform.

8. The transaction-based electronic contract forensics system according to claim 6, wherein the blockchain digital deposit platform is further configured to perform a step of verifying validity of a private key, to verify validity of a private-key signature of the deposit transaction;
and decrypte the digest to generate the storage index table, if the private-key signature is valid.

9. A transaction-based electronic contract forensics system, comprising an electronic contract platform configured to initiate a forensics request, and a blockchain digital deposit platform that receives the forensics request, and stores and retrieves an electronic contract based on a transaction, wherein
the electronic contract platform is configured with:
a request initiation step: initiating a forensics request for the electronic contract;
the blockchain digital deposit platform is configured with:
a digest obtaining step: obtaining a digest of a corresponding deposit transaction based on the forensics request for the electronic contract;
a storage index table generation step: decrypting the digest to generate a storage index table;
a transaction data generation step: downloading corresponding distributed storage data according to the storage index table and splicing the data to obtain transaction data; and
a transaction data decryption step: decrypting the transaction data;
the electronic contract platform is further configured with:
a verification step: verifying validity, legitimacy, and integrity of the decrypted transaction data, and transmitting a verification result to the blockchain digital deposit platform; and
the blockchain digital deposit platform is further configured with:
a forensics report generation step: receiving the verification result, of the decrypted transaction data, that is transmitted by the electronic contract platform, to generate a forensics report.

10. The transaction-based electronic contract forensics system according to claim 9, wherein the obtaining a digest of a corresponding deposit transaction based on a forensics request for an electronic contract is performed according to the following steps:
a forensics request obtaining step: obtaining the forensics request for the electronic contract;
a deposit information determining step: determining, based on the forensics request, whether deposit information corresponding to the electronic contract is stored in the blockchain digital deposit platform;
a hash value obtaining step: obtaining a transaction hash value corresponding to the deposit information if the deposit information is stored in the blockchain digital deposit platform;
a deposit transaction determining step: determining, based on the transaction hash value, whether the deposit transaction exists in the blockchain digital deposit platform; and
a digest obtaining step: obtaining the digest of the deposit transaction if the deposit transaction exists in the blockchain digital deposit platform.
